(19) United States
(12) Patent Application Publication
(10) Pub. No.: US 2014/0074432 A1
(43) Pub. Date: Mar. 13, 2014

(54) ELECTRONIC DEVICE AND METHOD FOR MEASURING OUTLINE OF OBJECT

(71) Applicants: HON HAI PRECISION INDUSTRY CO., LTD., New Taipei (TW); HONG FU JIN PRECISION INDUSTRY (ShenZhen) CO., LTD., ShenZhen (CN)

(72) Inventors: CHIH-KUANG CHANG, New Taipei (TW); XIN-YUAN WU, Shenzhen (CN); LU YANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/022,243

(22) Filed: Sep. 10, 2013

(30) Foreign Application Priority Data
Sep. 12, 2012 (CN) 2012103344933

(51) Int. Cl. G01B 21/20

(52) U.S. Cl. CPC G01B 21/20
USPC 702/167

(57) ABSTRACT

In a method for measuring an outline of an object, the method creates vectors according to adjacent points of the outline, calculates an included angle between every two adjacent vectors, obtains sampled points in the outline and direction vectors of the sampled points, obtains reference points corresponding to the sampled points, inserts a point between each two adjacent reference points, and creates a measurement program according to the reference points and inserted points. The method further obtains measurement points of the outline of the object using the measurement program, obtains a tolerance of each measurement point and a tolerance of the outline of the object, and displays the tolerance of each measurement point using a graphic user interface.

### BACKGROUND

1. Technical Field

Embodiments of the present disclosure relate to measurement technology, and particularly to an electronic device and method for measuring an outline of an object using the electronic device.

2. Description of Related Art

Outline-measuring is important in product manufacturing to ensure product quality. For example, an object measurement system (e.g., probe measurement system) is used to measure an object. The probe measurement system measures the object by contacting a large number of points on a surface of the object using a probe.

However, the probe measurement system cannot use the probe to measure an outline of the object. Therefore, a more efficient method for measuring the outline of the object is desired.

### BRIEF DESCRIPTION OF THE DRAWINGS

FIG. 1 is a block diagram of one embodiment of an electronic device including a outline measurement system.

FIG. 2 is an schematic diagram of an example of an object measurement machine.

FIG. 3 is a schematic diagram of function modules of the outline measurement system included in the electronic device.

FIG. 4 is a flowchart of one embodiment of a method for measuring an outline of an object using the electronic device.

FIG. 5 is a detailed flowchart of step S2 in FIG. 4.

FIG. 6 is an exemplary schematic diagram of sampling points in the outline of the object.

FIG. 7 is a detailed flowchart of step S3 in FIG. 4.

FIG. 8 is an exemplary schematic diagram of inserting a point between two reference points of the outline of the object.

FIG. 9 is an exemplary schematic diagram of a measurement program created according to the reference points and inserted points.

FIG. 10 is a detailed flowchart of step S4 in FIG. 4.

FIG. 11 is an exemplary schematic diagram of calculating a tolerance of the outline of the object.

FIG. 12 is a detailed flowchart of step S5 in FIG. 4.

FIG. 13 is an exemplary schematic diagram of setting connecting lines of measurement points of the outline of the object with different colors.

FIG. 14 is an exemplary schematic diagram of outputting measurement results with a graphic user interface.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive, or other suitable storage medium.

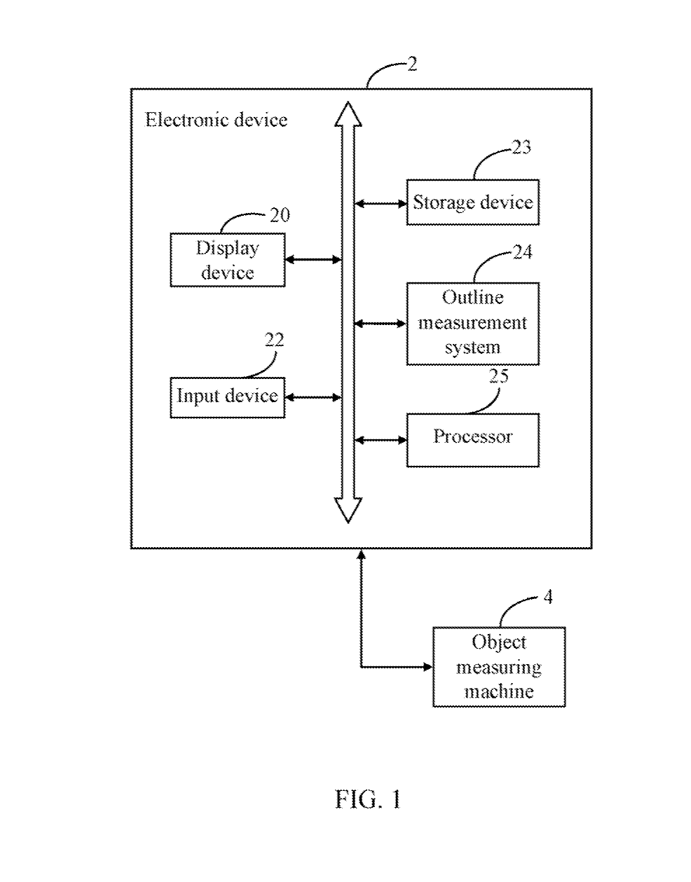

FIG. 1 is a block diagram of one embodiment of an electronic device 2 including an outline measurement system 24. The electronic device 2 may be connected with an object measurement machine 4 through a data bus. In the embodiment, the electronic device 2 further includes a display device 20, an input device 22, a storage device 23, and at least one processor 25. It should be understood that FIG. 1 illustrates only one example of the electronic device 2 that may include more or fewer components than illustrated, or a different configuration of the various components in other embodiments. The electronic device 2 may be a computer, a server, or any other computing device.

The display device 20 may be a liquid crystal display (LCD) or a cathode ray tube (CRT) display, and the input device 22 may be a mouse or a keyboard used to input computer readable data. The storage device 23 may be a hard disk or a flash memory.

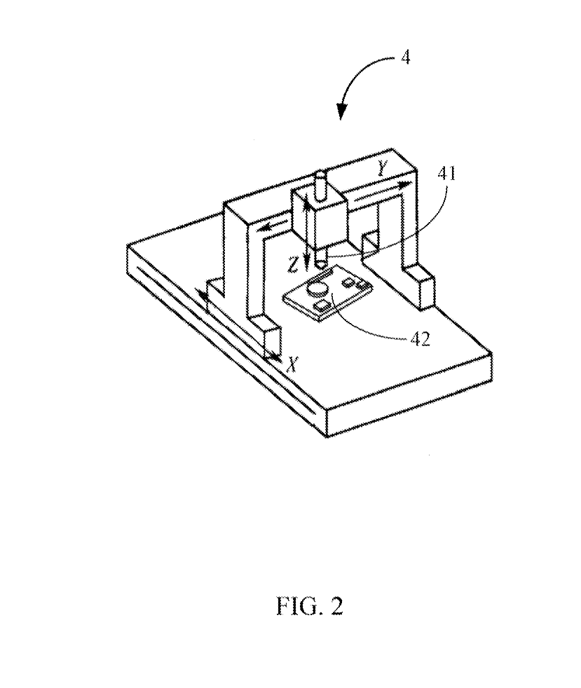

As shown in FIG. 2, the object measurement machine 4 may include, but is not limited to, a probe 41, an object 42 to be measured, and a plurality of driving units (not shown in FIG. 2). The driving units may include an X-axis driving motor, a Y-axis driving motor, and an Z-axis driving motor, and may be used to control the probe 41 moving along an X-axis direction, a Y-axis direction, and an Z-axis direction, to measure the object 42. For example, the object measurement machine 4 may be a three-dimensional measuring machine.

The outline measurement system 24 is used to automatically measure an outline of the object 42, obtain a tolerance of the outline of the object, and generate a measurement report with a graphic user interface. In one embodiment, the outline measurement system 24 may include computerized instructions in the form of one or more programs that are executed by the at least one processor 25 and stored in the storage device 23 (or memory). A detailed description of the outline measurement system 24 will be given in the following paragraphs.

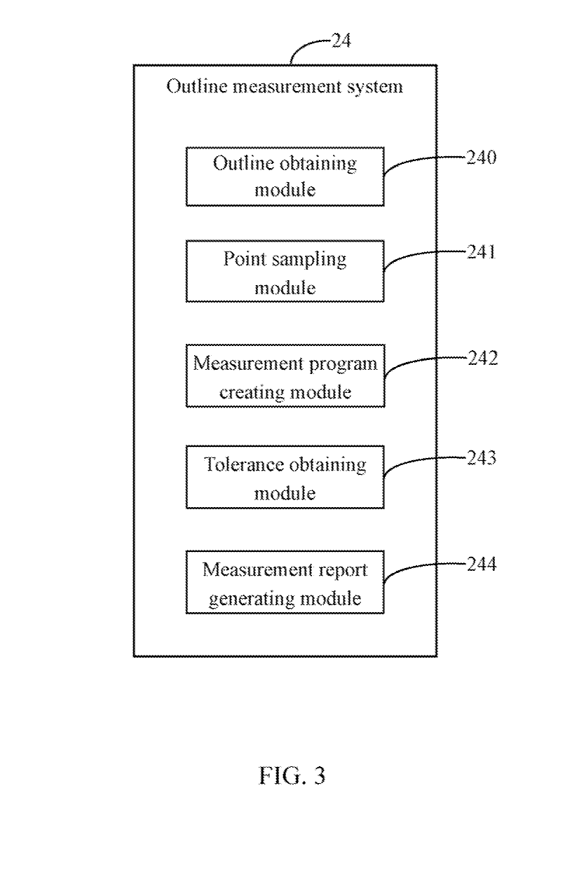

FIG. 3 is a schematic diagram of function modules of the outline measurement system 24 included in the electronic device 2. In one embodiment, the outline measurement system 24 may include one or more modules, for example, an outline obtaining module 240, a point sampling module 241, a measurement program creating module 242, a tolerance obtaining module 243, and a measurement report generating module 244.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, flash memory, and hard disk drives.

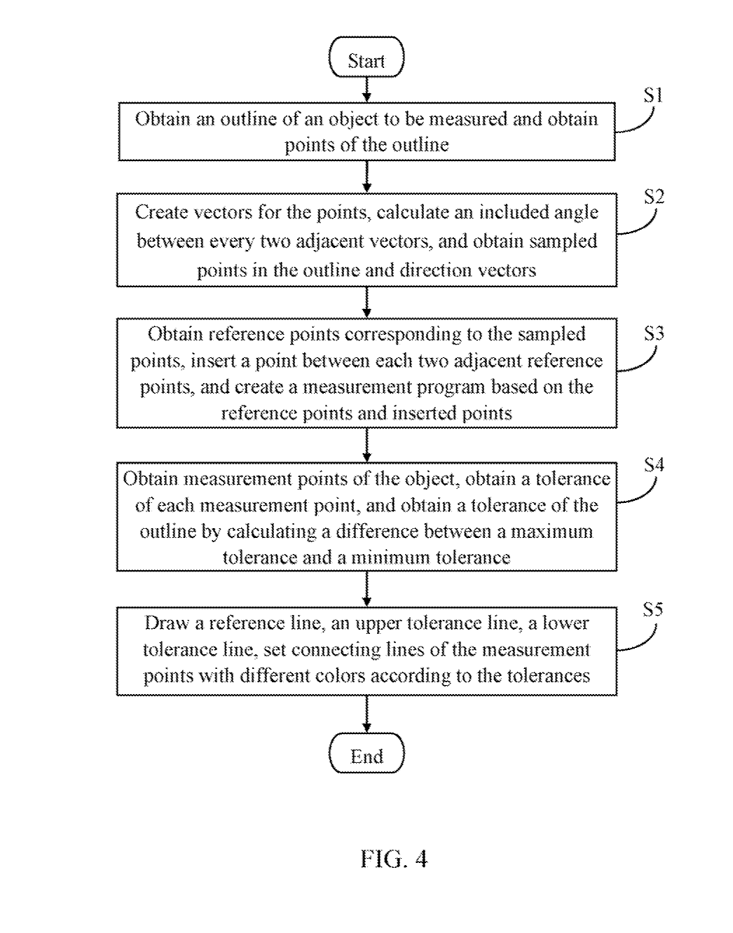

FIG. 4 is a flowchart of one embodiment of a method for measuring an outline of the object 42 using the electronic device 2. Depending on the embodiment, additional steps may be added, others removed, and the ordering of the steps may be changed.

In step S1, the outline obtaining module 240 obtains an outline of the object 42 and points of the outline from the storage device 23. For example, the outline obtaining module 240 obtains an image of the outline of the object 42 and coordinates of the points of the outline from the storage device 23.

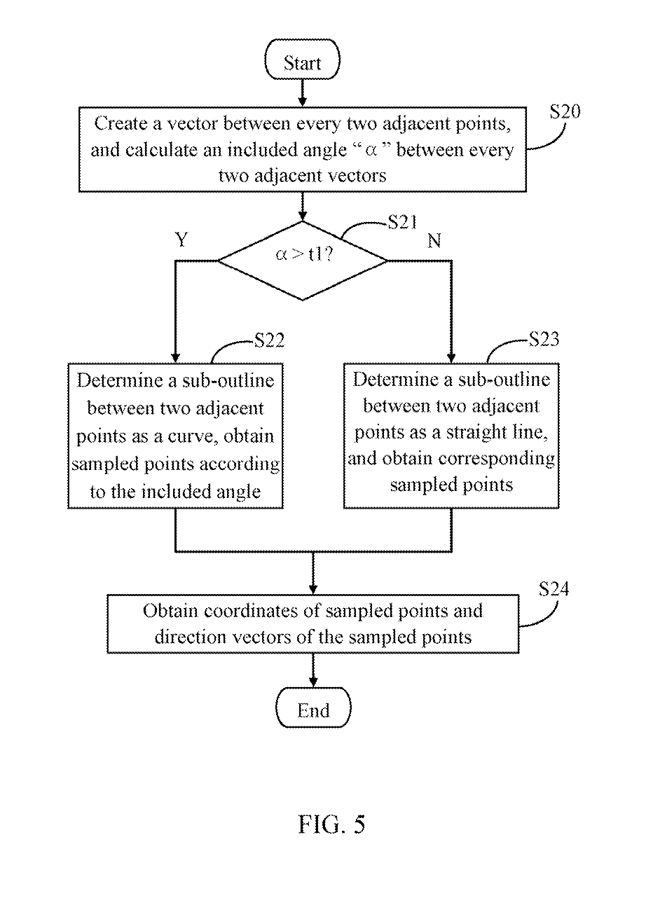

In step S2, the point sampling module 241 creates vectors for the points according to adjacent ones of the points, calculates an included angle between every two adjacent vectors, samples points in the outline of the object 42 according to the included angle, and obtains sampled points in the outline of the object 42 and direction vectors (directions of the corresponding vector) of the sampled points. A detailed description is provided in FIG. 5.

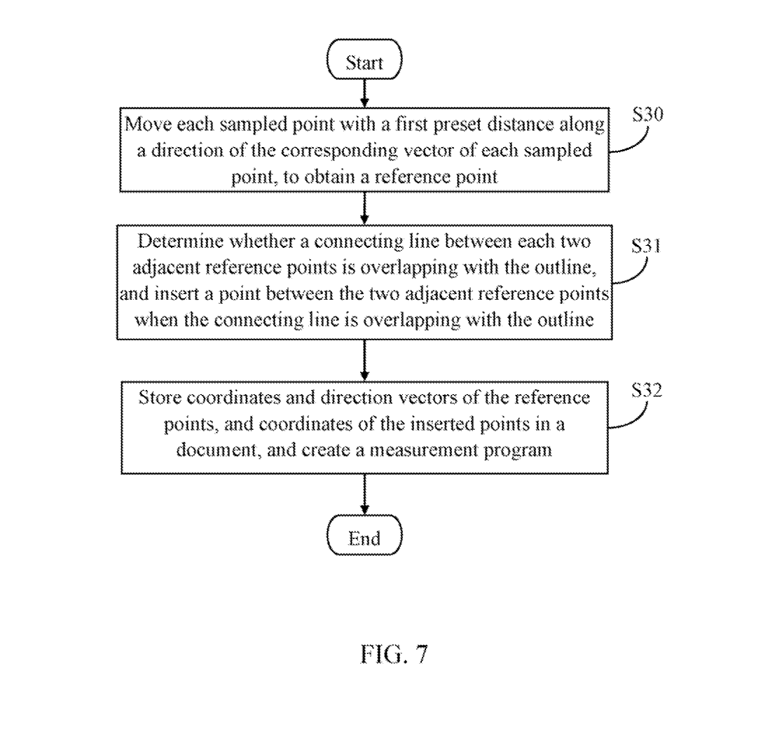

In step S3, the measurement program creating module 242 obtains reference points corresponding to the sampled points by moving each sampled point with a first preset distance along a direction of the corresponding vector of each sampled point, inserts a point between two adjacent reference points when a connecting line between the two adjacent reference points is overlapping with the outline, and creates a measurement program based on the reference points and inserted points. For example, the first preset distance may be 0.1 millimeters. A detailed description is provided in FIG. 7.

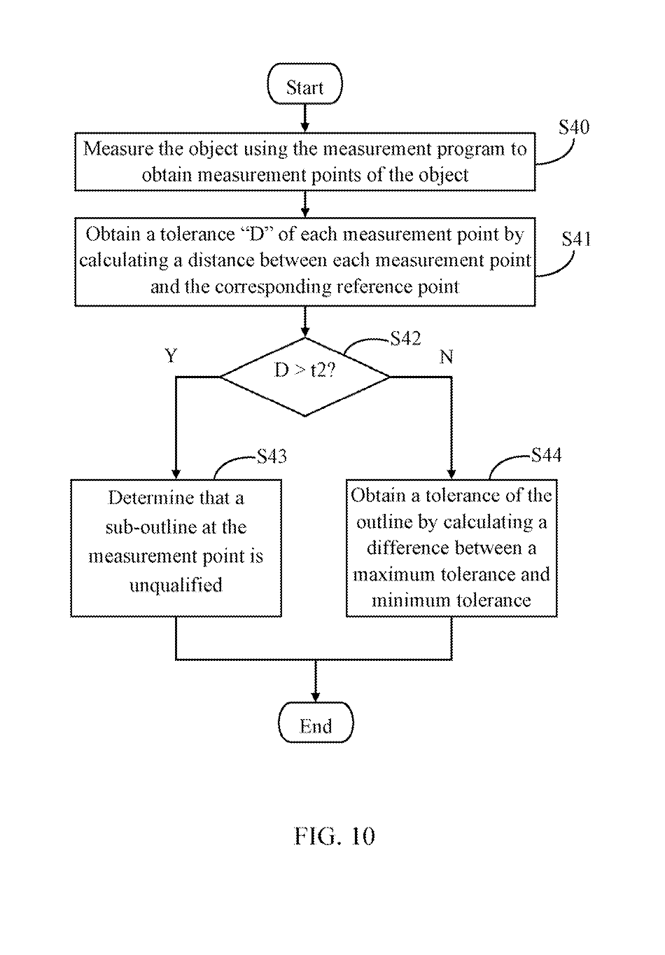

In step S4, the tolerance obtaining module 243 obtains measurement points of the outline of the object 42 by controlling movements of the probe 41 using the measurement program. In one embodiment, each reference point in the measurement program generates a corresponding measurement point. The reference points are points need to be measured in the measurement program, and the measurement points are actually points obtained by the probe 41 when the measurement program is executed. Then, the tolerance obtaining module 243 obtains a tolerance of each measurement point by calculating a distance between each measurement point and a corresponding reference point, to obtain tolerances of all the measurement points. The tolerance obtaining module 243 obtains a tolerance of the outline of the object 42 by calculating a difference between a maximum value of the tolerances of all the measurement points (maximum tolerance) and a minimum value of the tolerances of all the measurement points (minimum tolerance). A detailed description is provided in FIG. 10.

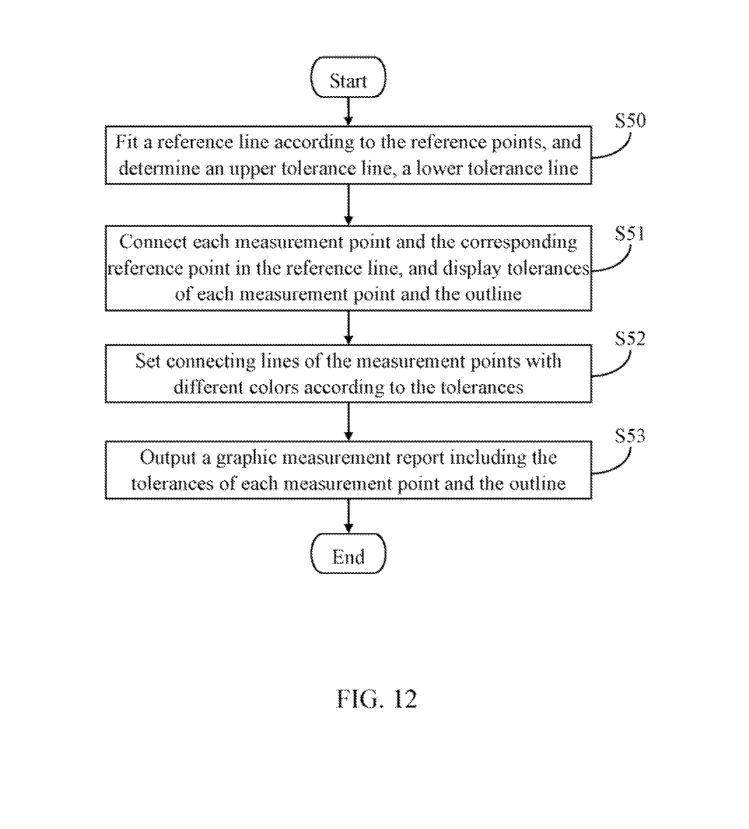

In step S5, the measurement report generating module 244 draws a reference line, an upper tolerance line, and a lower tolerance line according to the reference points, connects each measurement point and the corresponding reference point in the reference line, displays the tolerance of each measurement point on the display device 20, and sets connecting lines between adjacent measurement points with different colors according to the tolerance of each measurement point. A detailed description is provided in FIG. 12.

FIG. 5 is a detailed flowchart of step S2 in FIG. 4. Depending on the embodiment, additional steps may be added, others removed, and the ordering of the steps may be changed.

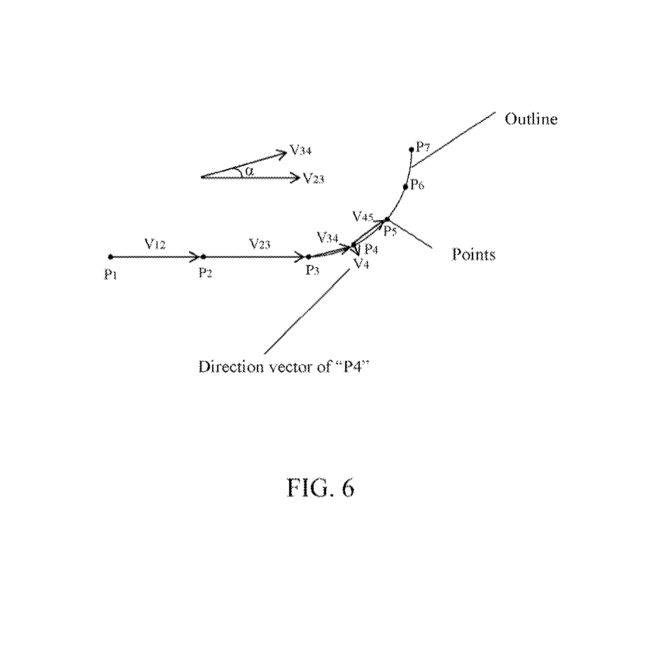

In step S20, the point sampling module 241 creates a vector between every two adjacent points, calculates an included angle “a” between every two adjacent vectors, and compares the included angle “a” with a first preset value “t1” (e.g., t1=5 degrees). For example, as shown in FIG. 6, “V23” represents a vector between the adjacent points “P2” and “P3”, “V34” represents a vector between the adjacent points “P3” and “P4”, and “a” represents the included angle between the two adjacent vectors “V23” and “V34”.

In step S21, the point sampling module 241 determines whether the included angle between two adjacent vectors is greater than the first preset value (α>t1). If the included angle between the two adjacent vectors is greater than the first preset value, step S22 is executed. If the included angle between the two adjacent vectors is less than or equal to the first preset value, step S23 is executed.

In step S22, the point sampling module 241 determines a sub-outline between two adjacent points as a curve, and obtains sampled points in the curve according to the included angle. For example, as shown in FIG. 6, if the included angle between two adjacent vectors “V23” and “V34” is greater than the first preset value, the sub-outline between the points “P3” and “P4” is determined as the curve. In one embodiment, when the included angle is bigger, the more sampled points are obtained. For example, if the included angle is greater than five degrees and is less than or equal to ten degrees, one sampled point is obtained. If the included angle is greater than ten degrees, two sampled points are obtained.

In step S23, the point sampling module 241 determines a sub-outline between the two adjacent points as a straight line, and obtains corresponding sampled points by moving the two adjacent points with a second preset distance toward a center position of the straight line. For example, the second preset distance is 0.2 millimeters.

In step S24, the point sampling module 241 obtains coordinates of the sampled points and direction vectors of the sampled points, and stores the coordinates and the direction vectors of the sampled points in a document (e.g. a text file). As shown in FIG. 6, “V4” represents the direction vector of the sampled point “P4”.

FIG. 7 is a detailed flowchart of step S3 in FIG. 4. Depending on the embodiment, additional steps may be added, others removed, and the ordering of the steps may be changed.

In step S30, the measurement program creating module 242 moves each sampled point with the first preset distance along the direction of the corresponding vector of each sampled point, and obtain a reference point corresponding to each sampled point. The reference points are used to measure the outline of the object 42. The probe 41 does not contact the outline of the object 42 directly, thus, the sampled points in the outline of the object 42 need to be moved with the first preset distance, such that the surface of the object 42 is not damaged by the probe 41 when the outline of the object 42 is measured.

In step S31, the measurement program creating module 242 determines whether a connecting line between each two adjacent reference points is overlapping with the outline of the object 42, and inserts a point between the two adjacent reference points when the connecting line is overlapping with the outline of the object 42, until the connecting line is not overlapping with the outline of the object 42.

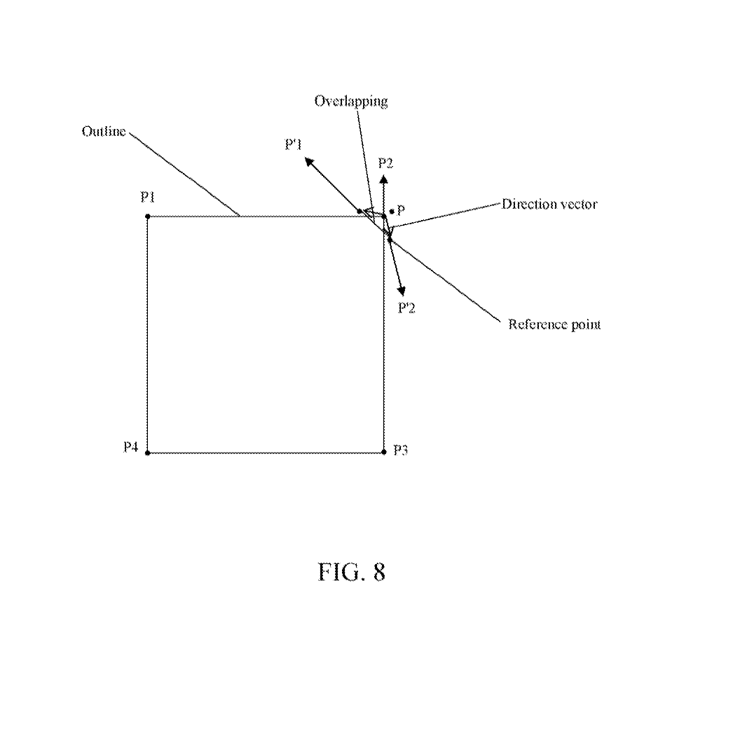

For example, as shown in FIG. 8, “P2” represents a sampled point in the outline of the object 42, because the sampled point “P2” is an end point of a sub-outline “P1P2”, and is also a start point of a sub-outline “P2P3”, two reference points of the sampled point “P2” are generated in FIG. 8, such as the reference points “P′1” and “P′2”. The connecting line between the reference points “P′1” and “P′2” is overlapping with the outline, thus, a point “P” is inserted between the reference points “P′1” and “P′2”. The inserted point “P” may be obtained by moving the point “P2” with a third preset distance towards a outside direction of the outline. For example, the third preset distance is 0.1 millimeters. Suppose (x1, y1) represents two-dimensional coordinates of the reference point “P′1”, (x2, y2) represents two-dimensional coordinates of the reference point “P′2”, and (x0, y0) represents two-dimensional coordinates of the inserted point “P”, thus, x1<x0<x2, and y1<y0<y2.

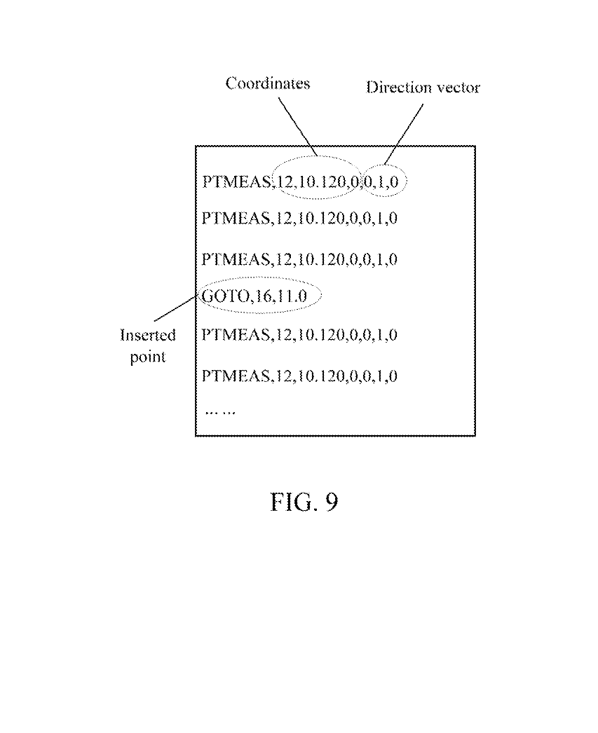

In step S32, the measurement program creating module 242 stores coordinates and direction vectors of the reference points, and coordinates of the inserted points in a document (e.g., a text file), and obtain a measurement program of the outline of the object 42. An example of the measurement program is shown in FIG. 9.

FIG. 10 is a detailed flowchart of step S4 in FIG. 4. Depending on the embodiment, additional steps may be added, others removed, and the ordering of the steps may be changed.

In step S40, the tolerance obtaining module 243 measures the outline of the object 42 by controlling movements of the probe 41 using the measurement program to obtain measurement points of the outline of the object 42.

In step S41, the tolerance obtaining module 243 obtains a tolerance “D” of each measurement point by calculating a distance between each measurement point and the corresponding reference point, and compares the tolerance “D” of each measurement point with a second preset value “t2”. For example, the second preset value is 0.01 millimeters.

In step S42, the tolerance obtaining module 243 determines whether the tolerance of each measurement point is greater than the second preset value (D>t2). If the tolerance of one measurement point is greater than the second preset value, step S43 is executed. If the tolerance of one measurement point is less than or equal to the second preset value, step S44 is executed.

In step S43, the tolerance obtaining module 243 determines that the tolerance of the measurement point is not within a tolerance range, and a sub-outline at the measurement point is unqualified.

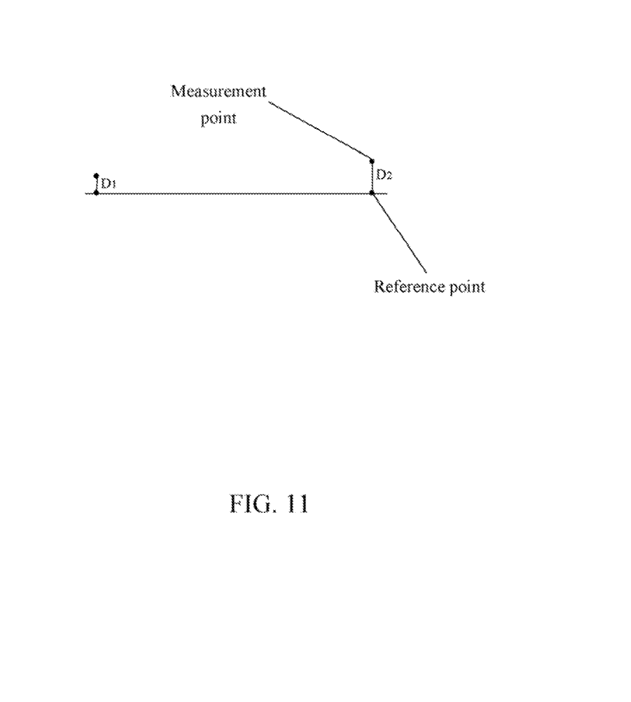

In step S43, the tolerance obtaining module 243 determines that the tolerance of the measurement point is within the tolerance range, and the sub-outline at the measurement point is qualified. Then, the tolerance obtaining module 243 obtains a tolerance of the outline of the object 42 by calculating a difference between a maximum tolerance and minimum tolerance of the measurement points. For example, as shown in FIG. 11, “D2” represents the maximum tolerance, “D1” represent the minimum tolerance, and the tolerance of the outline of the object 42 is determined as “D2−D1”.

FIG. 12 is a detailed flowchart of step S5 in FIG. 4. Depending on the embodiment, additional steps may be added, others removed, and the ordering of the steps may be changed.

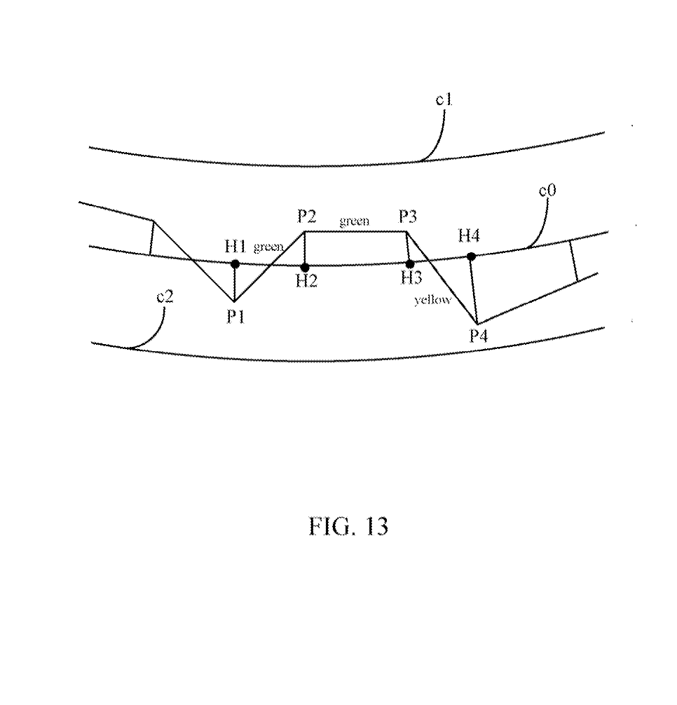

In step S50, the measurement report generating module 244 fits a reference line according to the reference points, and determines an upper tolerance line and a lower tolerance line according to the reference line. As shown in FIG. 13, “c0” represents the reference line, “c1” represents the maximum limit of the tolerance (the upper tolerance line), and “c2” represents the minimum limit of the tolerance (the lower tolerance line), “H1, H2, H3, and H4” represent the reference points, and “P1, P2, P3, and P4” represent the measurement points.

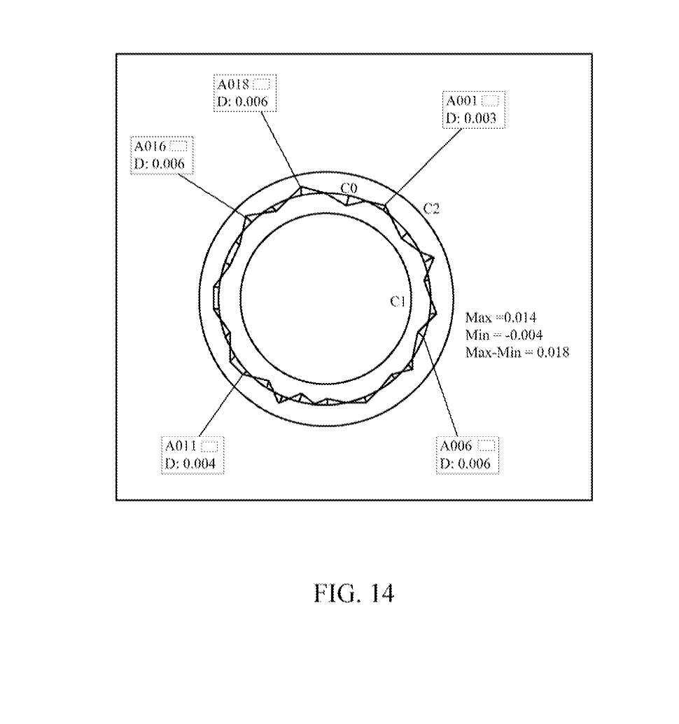

In step S51, the measurement report generating module 244 connects each measurement point and the corresponding reference point in the reference line, and displays the tolerance of each measurement point and the tolerance of the outline of the object 42 in a graphic user interface (refers to FIG. 14). As shown in FIG. 14, the tolerance of a measurement point “A001” is 0.003 millimeters. The maximum tolerance of all the measurement points is 0.014 millimeters, and the minimum tolerance of all the measurement points is −0.004 millimeters. Thus, the tolerance of the outline of the object 42 is determined as (0.014−(−0.004))=0.018 millimeters.

In step S52, the measurement report generating module 244 sets connecting lines of the measurement points with different colors according to the tolerances of the measurement points. In one embodiment, if the tolerance of a first measurement point is within a preset tolerance range, the measurement report generating module 244 determines a second measurement adjacent to the first measurement point, and sets a connecting line between the first measurement point and the second measurement point as a preset color corresponding to the preset tolerance range.

For example, as shown in FIG. 13, if the tolerance of the measurement point P1 is within a first tolerance range (e.g., [−0.005, 0.005]), the color of the connecting line “P1P2” is set as a first color (e.g., green). If the tolerance of the measurement point P3 is within a second tolerance range (e.g., [0.005, 0.010]), the color of the connecting line “P3P4” is set as a second color (e.g., yellow).

In step S52, the measurement report generating module 244 sets connecting lines of the measurement points with different colors according to the tolerances of the measurement points. In one embodiment, if the tolerance of a first measurement point is within a preset tolerance range, the measurement report generating module 244 determines a second measurement adjacent to the first measurement point, and sets a connecting line between the first measurement point and the second measurement point as a preset color corresponding to the preset tolerance range.

For example, as shown in FIG. 13, if the tolerance of the measurement point P1 is within a first tolerance range (e.g., [−0.005, 0.005]), the color of the connecting line “P1P2” is set as a first color (e.g., green). If the tolerance of the measurement point P3 is within a second tolerance range (e.g., [0.005, 0.010]), the color of the connecting line “P3P4” is set as a second color (e.g., yellow).

In other embodiments, the measurement report generating module 244 may set connecting lines between the measurement points and the reference points with different colors according to the tolerances of the measurement points. For example, if the tolerance of a first measurement point is within a preset tolerance range, the measurement report generating module 244 determines a first reference point corresponding to the first measurement point, and sets a connecting line between the first measurement point and the first reference point as a preset color corresponding to the preset tolerance range.

For example, as shown in FIG. 13, if the tolerance of the measurement point P1 is within a first tolerance range (e.g., [−0.005, 0.005]), the color of the connecting line “P1H1” is set as a first color (e.g., green). If the tolerance of the measurement point P3 is within a second tolerance range (e.g., [0.005, 0.010]), the color of the connecting line “P3H3” is set as a second color (e.g., yellow).

In other embodiments, step S52 may be removed from FIG. 12. Thus, no color is set for the connecting lines of between the adjacent measurement points and the connecting lines between the measurement points and the reference points.

In step S53, the measurement report generating module 244 outputs a graphic measurement report including the tolerance of each measurement point and the tolerance of the outline of the object 42. An example of the graphic measurement report is shown in FIG. 14.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for measuring an outline of an object using an electronic device, the method comprising:
obtaining the outline of the object and points of the outline from a storage device of the electronic device;
creating vectors for the points according to adjacent ones of the points, calculating an included angle between every two adjacent vectors, sampling points in the outline of the object according to the included angle, and obtaining sampled points in the outline of the object and direction vectors of the sampled points;
obtaining reference points corresponding to the sampled points by moving each of the sampled points with a first preset distance along a direction of the corresponding vector of each of the sampled points, inserting a point between each two adjacent reference points when a connecting line between the two adjacent reference points is overlapping with the outline of the object, and creating a measurement program according to the reference points and inserted points;
obtaining measurement points of the outline of the object using the measurement program, obtaining a tolerance of each of the measurement points by calculating a distance between each of the measurement points and a corresponding reference point, and obtaining a tolerance of the outline of the object by calculating a difference between a maximum tolerance and a minimum tolerance of the measurement points; and
drawing a reference line, an upper tolerance line, and a lower tolerance line according to the reference points, connecting each of the measurement points and a corresponding reference point in the reference line, and displaying the tolerance of each of the measurement points on a display device of the electronic device.

2. The method according to claim 1, wherein the sampled points and the direction vectors of the sampled points are obtained by:
creating a vector between every two adjacent points, and calculating an included angle between every two adjacent vectors;
determining a sub-outline between two adjacent points as a curve when the included angle between the two adjacent vectors is greater than a first preset value, and obtaining sampled points in the curve according to the included angle;
determining a sub-outline between two adjacent points as a straight line when the included angle between the two adjacent vectors is less than or equal to the first preset value, and obtaining sampled points by moving the two adjacent points with a second preset distance toward a center position of the straight line; and
obtaining coordinates of the sampled points and direction vectors of the sampled points, and storing the coordinates and the direction vectors of the sampled points in a document.

3. The method according to claim 1, wherein the measurement program comprises coordinates of the reference points and the inserted points, and the direction vectors of the reference points.

4. The method according to claim 1, further comprising:
setting connecting lines between adjacent measurement points with different colors according to the tolerance of each of the measurement points.

5. The method according to claim 4, wherein the colors of the connecting lines between the adjacent measurement points are set by:
determining a second measurement adjacent to a first measurement point when the tolerance of the first measurement point is within in a preset tolerance range; and
setting a connecting line between the first measurement point and the second measurement point as a preset color corresponding to the preset tolerance range.

6. The method according to claim 1, further comprising:
setting connecting lines between the measurement points and the reference points with different colors according to the tolerances of the measurement points.

7. The method according to claim 6, wherein the colors of the connecting lines between the measurement points and the reference points are set by:
determining a first reference point corresponding to a first measurement point when the tolerance of the first measurement point is within in a preset tolerance range; and
setting a connecting line between the first measurement point and the first reference point as a preset color corresponding to the preset tolerance range.

8. An electronic device, comprising:
a processor;
a storage device storing a plurality of instructions, which when executed by the processor, causes the processor to:
obtain an outline of an object and points of the outline from the storage device;
create vectors for the points according to adjacent ones of the points, calculate an included angle between every two adjacent vectors, sample points in the outline of the object according to the included angle, and obtain sampled points in the outline of the object and direction vectors of the sampled points;
obtain reference points corresponding to the sampled points by moving each of the sampled points with a first preset distance along a direction of the corresponding vector of each of the sampled points, insert a point between each two adjacent reference points when a connecting line between the two adjacent reference points is overlapping with the outline of the object, and create a measurement program according to the reference points and inserted points;
obtain measurement points of the outline of the object using the measurement program, obtain a tolerance of each of the measurement points by calculating a distance between each of the measurement points and a corresponding reference point, and obtain a tolerance of the outline of the object by calculating a difference between a maximum tolerance and a minimum tolerance of the measurement points; and
draw a reference line, an upper tolerance line, and a lower tolerance line according to the reference points, connect each of the measurement points and a corresponding reference point in the reference line, and display the tolerance of each of the measurement points on a display device of the electronic device.

9. The electronic device according to claim 8, wherein the sampled points and the direction vectors of the sampled points are obtained by:
creating a vector between every two adjacent points, and calculating an included angle between every two adjacent vectors;
determining a sub-outline between two adjacent points as a curve when the included angle between the two adjacent vectors is greater than a first preset value, and obtaining sampled points in the curve according to the included angle;
determining a sub-outline between two adjacent points as a straight line when the included angle between the two adjacent vectors is less than or equal to the first preset value, and obtaining sampled points by moving the two adjacent points with a second preset distance toward a center position of the straight line; and
obtaining coordinates of the sampled points and direction vectors of the sampled points, and storing the coordinates and the direction vectors of the sampled points in a document.

10. The electronic device according to claim 8, wherein the measurement program comprises coordinates of the reference points and the inserted points, and the direction vectors of the reference points.

11. The electronic device according to claim 8, wherein the plurality of instructions further comprise:
setting connecting lines between adjacent measurement points with different colors according to the tolerance of each of the measurement points.

12. The electronic device according to claim 11, wherein the colors of the connecting lines between the adjacent measurement points are set by:
determining a second measurement adjacent to a first measurement point when the tolerance of the first measurement point is within a preset tolerance range; and
setting a connecting line between the first measurement point and the second measurement point as a preset color corresponding to the preset tolerance range.

13. The electronic device according to claim 8, wherein the plurality of instructions further comprise:
setting connecting lines between the measurement points and the reference points with different colors according to the tolerances of the measurement points.

14. The electronic device according to claim 13, wherein the colors of the connecting lines between the measurement points and the reference points are set by:
determining a first reference point corresponding to a first measurement point when the tolerance of the first measurement point is within a preset tolerance range; and
setting a connecting line between the first measurement point and the first reference point as a preset color corresponding to the preset tolerance range.

15. A non-transitory storage medium having stored thereon instructions that, when executed by a processor of an electronic device, causes the electronic device to perform a method for measuring an outline of an object, the method comprising:
obtaining the outline of the object and points of the outline from a storage device of the electronic device;
creating vectors for the points according to adjacent ones of the points, calculating an included angle between every two adjacent vectors, sampling points in the outline of the object according to the included angle, and obtaining sampled points in the outline of the object and direction vectors of the sampled points;
obtaining reference points corresponding to the sampled points by moving each of the sampled points with a first preset distance along a direction of the corresponding vector of each of the sampled points, inserting a point between each two adjacent reference points when a connecting line between the two adjacent reference points is overlapping with the outline of the object, and creating a measurement program according to the reference points and inserted points;
obtaining measurement points of the outline of the object using the measurement program, obtaining a tolerance of each of the measurement points by calculating a distance between each of the measurement points and a corresponding reference point, and obtaining a tolerance of the outline of the object by calculating a difference between a maximum tolerance and a minimum tolerance of the measurement points; and
drawing a reference line, an upper tolerance line, and a lower tolerance line according to the reference points, connecting each of the measurement points and a corresponding reference point in the reference line, and displaying the tolerance of each of the measurement points on a display device of the electronic device.

16. The non-transitory storage medium according to claim 15, wherein the sampled points and the direction vectors of the sampled points are obtained by:
creating a vector between every two adjacent points, and calculating an included angle between every two adjacent vectors;
determining a sub-outline between two adjacent points as a curve when the included angle between the two adjacent vectors is greater than a first preset value, and obtaining sampled points in the curve according to the included angle;
determining a sub-outline between two adjacent points as a straight line when the included angle between the two adjacent vectors is less than or equal to the first preset value, and obtaining sampled points by moving the two adjacent points with a second preset distance toward a center position of the straight line; and
obtaining coordinates of the sampled points and direction vectors of the sampled points, and storing the coordinates and the direction vectors of the sampled points in a document.

17. The non-transitory storage medium according to claim 15, wherein the measurement program comprises coordinates of the reference points and the inserted points, and the direction vectors of the reference points.

18. The non-transitory storage medium according to claim 15, wherein the method further comprises:
setting connecting lines between adjacent measurement points with different colors according to the tolerance of each of the measurement points.

19. The non-transitory storage medium according to claim 18, wherein the colors of the connecting lines between the adjacent measurement points are set by:
determining a second measurement adjacent to a first measurement point when the tolerance of the first measurement point is within a preset tolerance range; and
setting a connecting line between the first measurement point and the second measurement point as a preset color corresponding to the preset tolerance range.

20. The non-transitory storage medium according to claim 15, wherein the method further comprises:
setting connecting lines between the measurement points and the reference points with different colors according to the tolerances of the measurement points.
